(19) United States
(12) Patent Application Publication
(10) Pub. No.: US 2026/0135163 A1
(43) Pub. Date: May 14, 2026

(54) BATTERY MODULE

(71) Applicant: TOYOTA JIDOSHA KABUSHIKI KAISHA, Toyota-shi (JP)

(72) Inventor: Yukinari TANABE, Okazaki-shi (JP)

(73) Assignee: TOYOTA JIDOSHA KABUSHIKI KAISHA, Toyota-shi (JP)

(21) Appl. No.: 19/285,544

(22) Filed: Jul. 30, 2025

(30) Foreign Application Priority Data
Nov. 14, 2024 (JP) 2024-199164

(51) Int. Cl. H01M 10/42; H01M 50/213

(52) U.S. Cl. CPC H01M 10/4228; H01M 50/213

(57) ABSTRACT

A battery module includes a plurality of battery cells, a holder that is configured to accommodate the battery cells, a conductor that is arranged between the battery cells that are accommodated next to each other in the holder, and a leakage detection device that is electrically connected to the conductor.

### CROSS-REFERENCE TO RELATED APPLICATION

This application claims priority to Japanese Patent Application No. 2024-199164 filed on Nov. 14, 2024. The disclosure of the above-identified application, including the specification, drawings, and claims, is incorporated by reference herein in its entirety.

### BACKGROUND

### 1. Technical Field

The technology of the present disclosure relates to a battery module.

### 2. Description of Related Art

Battery modules are used in a variety of equipment. For example, batteries that are used in vehicles are used to supply power to electrical equipment that is installed in the vehicle, such as lamps and audio equipment, and in battery electric vehicles (EV) or the like, for supplying electric power to a traction motor. Lithium-ion batteries or the like are used as battery cells that are included in such battery modules, and some battery cells including lithium-ion batteries are filled with an electrolytic solution inside. In battery cells filled with such an electrolytic solution, there are cases in which the electrolytic solution leaks out from the battery cells, due to external impact or temperature rise that exceeds allowable temperature of the battery cells.

Japanese Unexamined Patent Application Publication No. 2008-34296 (JP 2008-34296 A) describes a method for detecting leakage of electrolytic solution, including a battery module, a battery case that accommodates the battery module, a tray that males up a lower part of the battery case, a recess provided in a position on the tray facing a lower face of the battery module, a pH sensor that is provided in the recess, and a water holding portion that is capable of holding water so as to be in contact with the pH sensor, by using the pH sensor to detect change in pH value due to reaction between electrolytic solution that is contained in the battery module and the water that is held in the water holding portion.

### SUMMARY

In order to promptly detect leakage occurring in a battery module, structure of the battery module, placement of the battery cells, and so forth, need to be taken into consideration. Accordingly, there is room for further improvement in technology for promptly detecting leakage occurring in a battery module.

In view of the foregoing circumstances, an object of the present disclosure is to provide a battery module that is capable of promptly detecting occurrence of leakage.

In order to achieve the above object, a battery module according to a first aspect of the present disclosure includes a plurality of battery cells, a holder that is configured to accommodate the battery cells, a conductor that is arranged between the battery cells that are accommodated in the holder, and a leakage detection device that is electrically connected to the conductor.

In the battery module according to the first aspect, occurrence of leakage can be promptly detected by the leakage detection device detecting electrolytic solution coming into contact with the conductor that is arranged between the battery cells.

With the battery module according to a second aspect of the present disclosure, in the battery module according to the first aspect of the present disclosure, the battery cells each include an electrode assembly, a housing that has an opening and that accommodates the electrode assembly, and a blocking member that blocks the opening of the housing, and the conductor is arranged at a position that is adjacent to the opening of the housing.

In the battery module according to the second aspect, the conductor is placed adjacent to the opening of the battery cell at which leakage is relatively likely to occur, and accordingly, occurrence of leakage can be detected in a shorter period of time.

With the battery module according to a third aspect of the present disclosure, in the battery module according to the second aspect of the present disclosure, the conductor is arranged on an outer peripheral face of the housing, adjacent to the opening.

In the battery module according to the third aspect, arranging the conductor on the outer peripheral face of the housing enables detection of occurrence of leakage of the electrolytic solution leaking from the battery cell before the electrolytic solution reaches the holder.

With the battery module according to a fourth aspect of the present disclosure, in the battery module according to the first aspect of the present disclosure, the holder has a plurality of accommodation holes, each of which is cylindrical, and each of which has an opening portion and accommodates one of the battery cells inside, and the conductor is arranged on the holder, at a position that is adjacent to the opening portion.

In the battery module according to the fourth aspect, work of disposing the conductor is easy.

With the battery module according to a fifth aspect of the present disclosure, in the battery module according to the fourth aspect of the present disclosure, in the holder, the accommodation holes are disposed such that positions of the opening portions of at least some of the accommodation holes are different in an up-down direction, and the conductor is arranged between the opening portions of the accommodation holes that are adjacent to each other in the up-down direction in the holder.

In the battery module according to the fifth aspect, occurrence of leakage can be detected before the electrolytic solution causes short-circuiting between the battery cells.

According to the battery module of the present disclosure, occurrence of leakage can be promptly detected.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a front view illustrating an example of a battery module according to an embodiment;

FIG. 2 is a schematic cross-sectional view illustrating an example of a battery cell that is illustrated in FIG. 1;

FIG. 3 is a schematic cross-sectional view taken along line A-A in FIG. 1;

FIG. 4 is an enlarged cross-sectional view illustrating a portion B in FIG. 3 in an enlarged manner;

FIG. 5A is an enlarged view illustrating a modification of a conductor, illustrating a position corresponding to a portion C in FIG. 1 in an enlarged manner;

FIG. 5B is an enlarged view illustrating a modification of the conductor, illustrating the position corresponding to the portion C in FIG. 1 in an enlarged manner; and

FIG. 6 is an enlarged view illustrating another modification of the conductor, corresponding to FIG. 3.

### DETAILED DESCRIPTION OF EMBODIMENTS

Embodiments for carrying out the present disclosure will be described below with reference to the drawings. Note that in the following, description of a scope necessary for achieving objectives of the present disclosure will be given schematically, primarily focusing on describing relevant parts of the present disclosure, and parts in which description is omitted will be based on publicly known technology. Also, members that are the same or equivalent are denoted by the same or similar signs in the drawings, and repetitive description will be omitted. Further, when a plurality of same or equivalent members is included in a drawing, just a few thereof may be denoted by signs, for the sake of viewability.

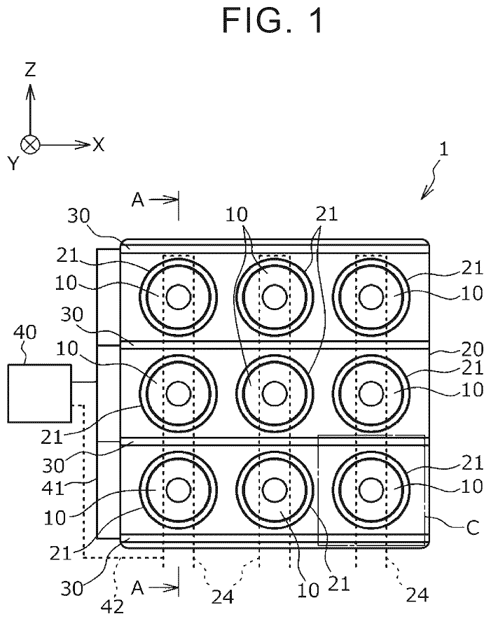

FIG. 1 is a front view illustrating an example of a battery module according to an embodiment. The battery module 1 according to the present embodiment may be capable of being installed in a vehicle such as a battery electric vehicle or the like. Note that in the following description, an X direction in FIG. 1 may be referred to as a “right-left direction”, a Y direction as a “front-rear direction”, and a Z direction as an “up-down direction”. Also, the battery module 1 illustrated in FIG. 1 is illustrated in a state of being disposed at a predetermined position inside a vehicle.

As illustrated in FIG. 1, the battery module 1 according to the present embodiment includes at least a plurality of battery cells 10, a holder 20 that is capable of accommodating the battery cells 10, conductors 30 that are arranged between the battery cells 10, and a leakage detection device 40 that is electrically connected to the conductors 30.

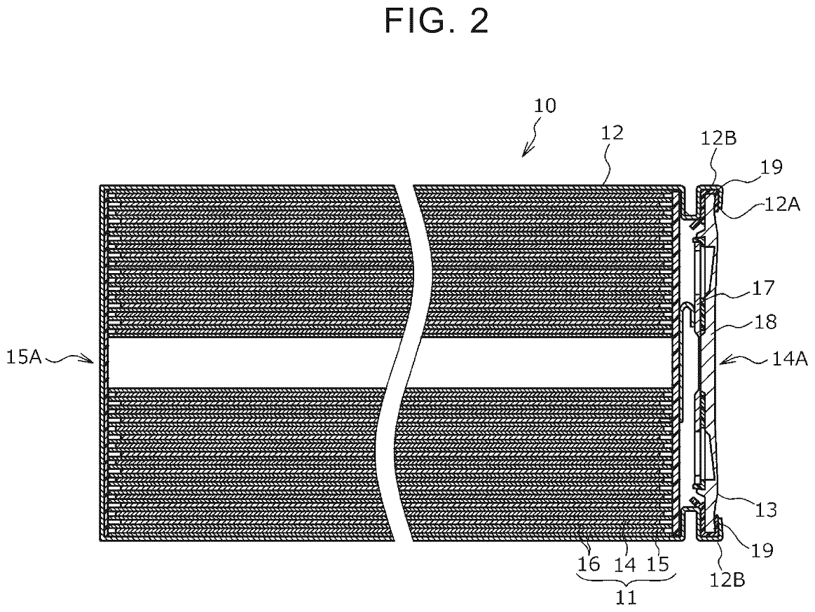

FIG. 2 is a cross-sectional view illustrating an example of one of the battery cells illustrated in FIG. 1. As illustrated in FIG. 1, the battery cell 10 can be made up of a secondary battery that contains an electrolytic solution therein, such as a lithium-ion battery. In the present embodiment, a battery cell 10 that is cylindrical is exemplified. This battery cell 10 may include, for example, an electrode assembly 11, a housing 12 that has an opening 12A and that accommodates the electrode assembly 11, and a blocking member 13 that blocks the opening 12A of the housing 12. Note that the shape and type of the battery cell 10 described above are exemplary, and are not limiting.

The electrode assembly 11 can be configured as a wound electrode assembly, for example. The electrode assembly 11 may have a structure in which a cathode 14 and an anode 15, which are strip-like in shape, are wound, in a state in which a separator 16, which is also strip-like in shape, interposed between them. Examples of materials that can be used for the cathode 14 include metals, such as cobalt, nickel, manganese, or iron phosphate-based materials, either singly or in combination. Also, examples of materials that can be used for the anode 15 include a carbon-based material or other alloys. Furthermore, a porous sheet having ion permeability and insulating properties can be employed as the separator 16, and examples of the material thereof that can be used include polyolefin-based resins including polyethylene and polypropylene, cellulose, and so forth.

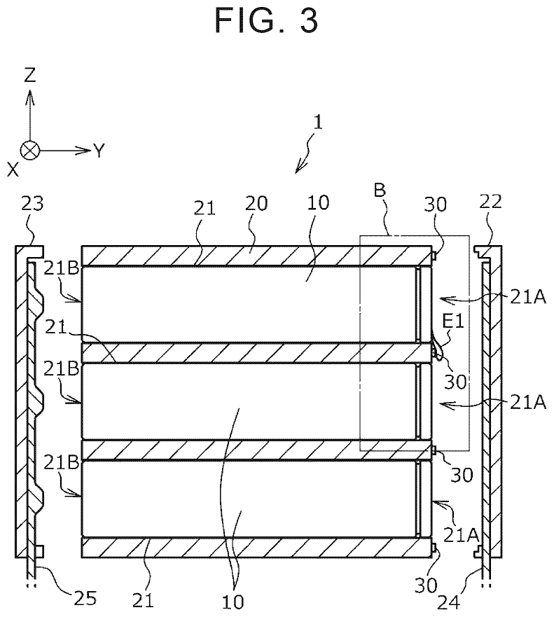

Also, an organic solvent such as ethylene carbonate, dimethyl carbonate, or diethyl carbonate, or the like, in which a lithium electrolyte salt has been dissolved, can be used for an electrolytic solution E1 (see FIG. 3) sealed in the battery cell 10. Note that the material and shape of each component making up the electrode assembly 11, the type of the electrolytic solution E1, and so forth, may be selected and employed as appropriate, based on the purpose of use of the battery module 1.

The housing 12 accommodates the electrode assembly 11 together with the electrolytic solution E1 therein, and can be formed of an encasing can that is made of a cylindrical metal container with a bottom. The opening 12A is provided in an upper part of the housing 12, and this opening 12A is sealed off by the blocking member 13 after the electrode assembly 11 and the electrolytic solution E1 are inserted into the housing 12. Also, this housing 12 can function as an anode terminal that is electrically connected to the anode 15, by connecting an end of the anode 15 that is wound or an anode lead, omitted from illustration, that is electrically connected to an appropriate position on the anode 15. The housing 12 can be manufactured by forming a metal plate into a cylindrical shape with a bottom, by drawing or the like. In the present embodiment, the middle of the bottom of the housing 12 functions as an anode contact 15A. Note that an insulator, which is omitted from illustration, is preferably wound in a cylindrical shape around an outer periphery of the housing 12, in order to protect the housing 12.

The blocking member 13 can be formed of a plate-like member that at least partially blocks the opening 12A of the housing 12. The blocking member 13 according to the present embodiment may include a terminal plate 17 that is electrically connected to the cathode 14, and a safety valve 18 that is placed facing the terminal plate 17.

The terminal plate 17 can be configured as a substantially disk-shaped plate that is made of metal, such as aluminum or an aluminum alloy, for example. The terminal plate 17 may be partially joined to the safety valve 18 by welding, or by an adhesive or the like. Also, an insulating material may be arranged in an appropriate location between the terminal plate 17 and the safety valve 18.

The safety valve 18 can be formed of a substantially disk-shaped plate that has a diameter larger than that of the terminal plate 17. The safety valve 18 can be fabricated by stamping a plate of metal such as aluminum or an aluminum alloy, for example. When pressure inside the housing 12 rises due to abnormal heat generation or the like, from the electrode assembly 11, the safety valve 18 is pressed by the pressure and thus is inverted, thereby functioning as a so-called relief valve that suppresses damage to the housing 12. Also, the middle portion of the safety valve 18 functions as a cathode contact 14A. Note that the above-described configuration of the blocking member 13 is merely one example, and the specific configuration and shape of the blocking member 13 can be changed as appropriate.

The opening 12A of the housing 12 is sealed by crimping and fixing an edge portion of the blocking member 13, having the above-described configuration, to a crimping portion 12B that is adjacent to the opening 12A. The crimping portion 12B according to the present embodiment is crimped so as to fix the edge portion of the blocking member 13, more specifically an outer periphery of the safety valve 18, with a gasket 19 that is made of a relatively pliable insulating material or the like interposed therebetween. The crimping and fixing is performed by applying pressure to the crimping portion 12B along an axial direction of the battery cell 10, using a pressure device that is omitted from illustration. After being fixed by crimping, a cross-sectional shape of the crimping portion 12B is substantially U-shaped, opening toward the inward side, as illustrated in FIG. 2. The gasket 19 described above functions as a sealing member for ensuring airtightness of the battery cell 10, and as an insulator for electrically insulating the housing 12 and the terminal plate 17.

In the battery cell 10 having the above-described configuration, strength at the vicinity of the opening 12A of the housing 12, more specifically the crimping portion 12B, is lower than that of other portions, due to the structure of the housing 12. Also, when the safety valve 18 is activated, a gap may be formed through which the electrolytic solution E1 leaks. Accordingly, when an increase in pressure occurs inside the housing 12 due to abnormal heating or the like of the electrode assembly 11, for example, or when the housing 12 is subjected to external impact, the likelihood that the electrolytic solution E1 inside the housing 12 will leak out of the housing 12 through the crimping portion 12B or the safety valve 18 is high. The battery module 1 according to the present embodiment employs a configuration for promptly detecting occurrence of leakage from the battery cells 10 described above.

As illustrated in FIG. 1, the holder 20 is capable of accommodating the battery cells 10 having the configuration described above, and can be made of an insulating material such as a resin material or the like. The holder 20 can be configured as a block body that is generally rectangular in frontal view, and a length thereof in the front-rear direction is preferably adjusted to match an axial direction length of the battery cells 10 that are accommodated therein. The holder 20 is also provided with a plurality of accommodation holes 21 extending in the front-rear direction. The holder 20 may be disposed such that first openings 21A, each serving as an example of at least a part of an opening portion of the accommodation hole 21, are positioned at different positions in the up-down direction. The holder 20 according to the present embodiment has a total of nine accommodation holes 21, placed so as to be arrayed at predetermined intervals, in three columns in the up-down direction and three rows in the right-left direction.

Each of the accommodation holes 21, which the holder 20 is provided with, accommodates one battery cell 10. Accordingly, the number of the battery cells 10 accommodated in the holder 20 is the same as the number of the accommodation holes 21. The accommodation holes 21 according to the present embodiment extend in the front-rear direction, and also both ends in the extending direction thereof are open to a front face and a rear face of the holder 20, as first opening portions 21A and second opening portions 21B. In other words, the accommodation holes 21 according to the present embodiment can be configured as through holes that pass through the holder 20 in the front-rear direction. The battery cells 10, of which at least part thereof is accommodated in the multiple accommodation holes 21, are inserted into the accommodation holes 21 in an orientation with the cathode contact 14A situated at the front face of the holder 20. Note that the orientation of the battery cells 10 that are accommodated in the accommodation holes 21 is not limited to the above. For example, the multiple battery cells 10 may be accommodated in each of the accommodation holes 21 such that the contact points of the battery cells 10 differ from those of adjacent battery cells 10 when the battery module 1 is viewed from the front. In this case, the placement and connection method of the bus bar, which will be described later, is also changed as appropriate. The first opening portions 21A and the second opening portions 21B can also function as insertion ports for the battery cells 10.

FIG. 3 is a schematic cross-sectional view taken along line A-A in FIG. 1. Note that FIG. 3 illustrates just the battery cells 10, from among the components of the battery module 1, in side view, for the sake of viewability. As illustrated in FIG. 3, a first cover 22 and a second cover 23 are attached to the front face and the rear face of the holder 20 according to the present embodiment.

The first cover 22 can be configured as a plate-like member that covers the front face of the holder 20. A cathode bus bar 24 is disposed on a face of the first cover 22 facing the front face of the holder 20. When the first cover 22 is attached to the front face of the holder 20, the cathode bus bar 24 is routed over positions facing the cathode contacts 14A of the battery cells 10, so as to be electrically connected to all of the cathode contacts 14A via lead terminals or the like, which are omitted from illustration.

The second cover 23 can be configured as a plate-like member that covers the rear face of the holder 20. An anode bus bar 25 is disposed on a face of the second cover 23 facing the rear face of the holder 20. When the second cover 23 is attached to the rear face of the holder 20, the anode bus bar 25 is routed over positions facing the anode contacts 15A of the battery cells 10, so as to be electrically connected to all of the anode contacts 15A. The anode bus bar 25 and the above-described cathode bus bar 24 may be connected to a control device, omitted from illustration, that controls charging and discharging of the battery module 1. Note that the first and second covers 22 and 23 can be omitted.

The conductors 30 are arranged between the battery cells 10 accommodated in the accommodation holes 21 of the holder 20. More preferably, the conductors 30 are arranged at positions adjacent to the openings 12A of the housings 12 of the battery cells 10. The reason for the conductors 30 being arranged at positions adjacent to the openings 12A of the housings 12 is because, as described above, leakage of the electrolytic solution E1 is likely to occur at the openings 12A, and accordingly leakage from the battery cell 10 can be detected more promptly than when the conductors 30 are arranged at positions away from the openings 12A. As illustrated in FIG. 1, the conductors 30 according to the present embodiment are made up of a plurality of metal plates, elongated in the right-left direction, and arranged at positions adjacent to the first opening portions 21A of the accommodation holes 21 in which the above-described openings 12A are situated. Thus, placing the conductors 30 on a surface of the holder 20 is preferable since work of disposing the conductors 30 is easy.

Also, within the surroundings of the battery cells 10, the conductors 30 are preferably arranged between the battery cells 10 that are adjacent to each other in the up-down direction, in a state in which the battery module 1 is disposed in a usage position. In the structure according to the present embodiment, the conductors 30 are preferably arranged at least downward from the battery cells 10. This is because, when one of the conductors 30 is placed downward from one of the battery cells 10, the conductor 30 can be promptly brought into contact with the electrolytic solution E1 leaking and flowing down from the battery cell 10, specifically, before coming into contact with another battery cell 10 that is situated downward from the one of the battery cells 10. Also, although the conductors 30 according to the present embodiment are exemplified as being disposed by being joined to the front face of the holder 20 by adhesive or the like, the conductors 30 may be disposed so as to be at least partially embedded in the front face of the holder 20.

The leakage detection device 40 may be electrically connected to the conductors 30 via a first conductive wire 41. The leakage detection device 40 may detect leakage by detecting that the electrolytic solution E1 has come into contact with the conductors 30. The leakage detection device 40 according to the present embodiment is electrically connected to the battery cells 10 or to the bus bar that is connected to the battery cells 10 via a second conductive wire 42. The leakage detection device 40 according to the present embodiment detects that the electrolytic solution E1 has come into contact with the conductors 30 by detecting change in electrical resistance between the conductors 30 and the battery cells 10. Employing such a detection technique enables leakage to be detected with no connection to a ground line or the like of a vehicle body, which is suitable. Note that the specific detection method of the leakage detection device 40 is not limited to the above, and other methods that are capable of electrically detecting contact between the conductors 30 and the electrolytic solution E1 can be employed.

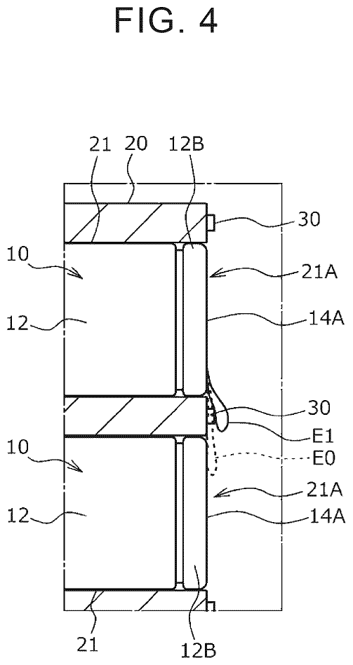

FIG. 4 is an enlarged cross-sectional view illustrating a portion B in FIG. 3 in an enlarged manner. In the battery module 1 according to the present embodiment that has the above-described configuration, when the electrolytic solution E1 leaks from one of the battery cells 10 in an upper row, as illustrated in FIGS. 3 and 4, for example, the electrolytic solution E1 that has leaked flows downward along the front face of the holder 20. Now, assuming a case in which the battery module 1 does not include the conductors 30 described above, electrolytic solution E0 leaking from one of the battery cells 10 will flow down the front face of the holder 20 and then come into contact with another battery cell 10 that is situated downward from the one of the battery cells 10, as illustrated in FIG. 4, thereby causing short-circuiting between the two battery cells 10. Such short-circuiting is a cause of deterioration of the battery cells 10, and preferably is averted. In the battery module 1 according to the present embodiment, the conductors 30 and the leakage detection device 40, which are described above, are employed in order to suppress occurrence of the above-described short-circuiting.

In further detail, the electrolytic solution E1 leaking from one of the battery cells 10 in the upper row generally has a certain level of viscosity, and accordingly, after flowing out from the battery cell 10, flows along the front face of the holder 20, and thus comes into contact with the conductor 30 that is disposed downward from the one of the battery cells 10 before coming into contact with another battery cell 10 that is situated in a lower row, as illustrated in FIG. 3. When the electrolytic solution E1 comes into contact with the conductor 30, electricity flows between the battery cell 10 and the conductor 30, and accordingly the electrical resistance between the battery cell 10 and the conductor 30 changes. The leakage detection device 40 can detect that leakage has occurred in one of the battery cells 10 by detecting the change in the electrical resistance described above. The occurrence of leakage may be notified to a user, such as a vehicle occupant for example, via a user interface that is omitted from illustration, such as a display monitor, a speaker, or the like.

It should be noted in particular here that the conductors 30 according to the present embodiment are arranged between the battery cells 10. Placing the conductors 30 as described above enables the electrolytic solution E1 leaking out from one of the battery cells 10 to be brought into contact with the conductor 30 before coming into contact with another adjacent battery cell 10 and causing short-circuiting between the battery cells 10, thus, short-circuiting between the battery cells 10 can be suppressed. Also, short-circuiting of the battery cells 10 with each other causes deterioration of the battery cells 10 to progress rapidly, but employing the above-described placement of the conductors 30 enables rapid progression of deterioration to be averted. Prompt detection of the occurrence of leakage enables prompt repair of the battery cell 10 in which leakage has occurred, and hence, the battery cell 10 can be used for a long time.

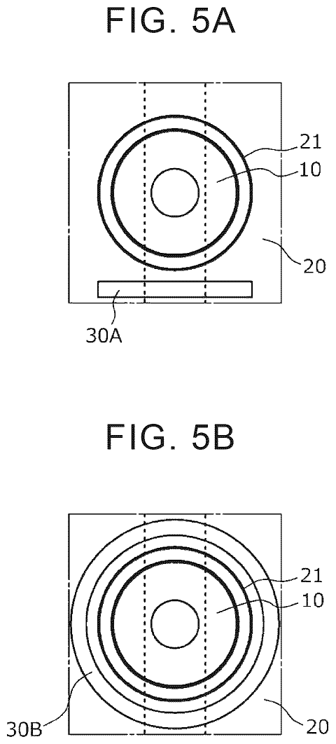

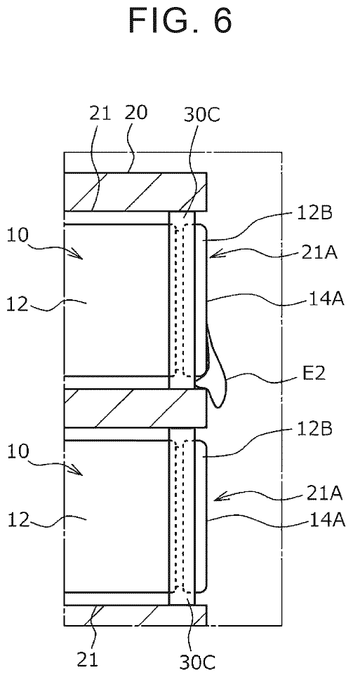

Hereinafter, several modifications of the conductors of the battery module 1 according to the above-described embodiment will be described with reference to FIGS. 5A, 5B, and 6. FIGS. 5A and 5B are enlarged views illustrating modifications of conductors, illustrating a position corresponding to a portion C in FIG. 1 in an enlarged manner. Also, FIG. 6 is an enlarged view illustrating another modification of the conductor, corresponding to FIG. 3.

In the above-described embodiment, a case of using multiple metal plates extending in the right-left direction across lower parts of the battery cells 10 for the conductors 30 has been exemplified, but the shapes and placement of the conductors 30 are not limited to this. Specifically, a conductor 30A that is independent can also be arranged at the lower part of one of the battery cells 10, for example, as in the modification illustrated in FIG. 5A. Thus, placing the conductor 30A for each of the battery cells 10, and also monitoring the insulation resistance between each of the conductors 30A and each of the battery cells 10 in the leakage detection device 40, enables a battery cell 10 in which leakage has occurred to be identified immediately.

Also, a conductor 30B that is formed in a ring shape can be arranged so as to surround the entire periphery of each of the battery cells 10, for example, as in the modification illustrated in FIG. 5B. Employing such a conductor 30B improves the degree of freedom in the disposing orientation of the battery module 1.

Furthermore, while a case has been exemplified in which the conductors 30, 30A, and 30B are arranged in the holder 20 in the embodiment and the modifications described above, the conductors may be arranged in the battery cells 10. Specifically, each of conductors 30C made of a metal plate formed into a ring shape may be arranged on an outer peripheral face of the housing 12, adjacent to the opening 12A thereof, via an insulating material that is omitted from illustration, for example, as illustrated in FIG. 6. When leakage occurs in a battery cell 10 in which the conductor 30C is arranged, electrolytic solution E2 leaking out from the battery cell 10 can be brought into contact with the conductor 30C by at least partially entering into a region that is defined by the outer peripheral face of the housing 12, an inner peripheral face of the accommodation hole 21, and the conductor 30C.

The several modifications that are described above can also yield the same effects as those described in the above embodiment. Note that the placements and shapes of the conductors described in the above embodiment and several modifications are merely examples, and limiting the conductors according to the present disclosure to these structures is not intended.

Also, while a structure in which the second cover 23 is attached to the rear face of the holder 20 is employed in the above embodiment, the second cover 23 can be integrally formed as part of the holder 20. Also, while an arrangement is exemplified in which the accommodation holes 21 that are provided in the holder 20 are placed arrayed in a straight line along the up-down direction in the above-described embodiment, right-left direction positions of accommodation holes 21 that are adjacent in the up-down direction may be offset. Further, the number and the placement of the accommodation holes 21 can be changed as appropriate.

Furthermore, while an arrangement is exemplified in the above embodiment and several modifications, in which conductors are arranged around all of the battery cells that are accommodated in the holder, an arrangement can be made in which conductors are arranged around just some of the battery cells 10 that are accommodated in the holder 20.

The present disclosure is not limited to the above-described embodiment, can be carried out modified variously without departing from the spirit and scope of the present disclosure. All of these are included in the technical spirit of the present disclosure. Also, each component of the present disclosure is not limited to one, and a plurality thereof may be present, unless otherwise specified in the specification.

What is claimed is:

1. A battery module, comprising:
a plurality of battery cells;
a holder that is configured to accommodate the battery cells;
a conductor that is arranged between the battery cells that are accommodated in the holder; and
a leakage detection device that is electrically connected to the conductor.

2. The battery module according to claim 1, wherein:
the battery cells each include an electrode assembly, a housing that has an opening and that accommodates the electrode assembly, and a blocking member that blocks the opening; and
the conductor is arranged at a position that is adjacent to the opening.

3. The battery module according to claim 2, wherein the conductor is arranged on an outer peripheral face of the housing, adjacent to the opening.

4. The battery module according to claim 1, wherein:
the holder has a plurality of accommodation holes, each of which is cylindrical, and each of which has an opening portion and accommodates one of the battery cells inside; and
the conductor is arranged on the holder, at a position that is adjacent to the opening portion.

5. The battery module according to claim 4, wherein:
in the holder, the accommodation holes are disposed such that positions of the opening portions of at least some of the accommodation holes are different in an up-down direction; and
the conductor is arranged between the opening portions of the accommodation holes that are adjacent to each other in the up-down direction in the holder.
